(19) United States
(12) Patent Application Publication
(10) Pub. No.: US 2004/0017840 A1
(43) Pub. Date: Jan. 29, 2004

(54) High data-rate communication apparatus and associated methods

(76) Inventor: Kazimierz Siwiak, Coral Springs, FL (US)

Correspondence Address: Maximilian R. Peterson, O'KEEFE, EGAN & PETERMAN, Building C, Suite 200, 1101 Capital of Texas Highway South, Austin, TX, 78746, US

(21) Appl. No.: 10/206,648

(22) Filed: Jul. 26, 2002

(51) Int. Cl. H04B 1/69; H04K 1/00; H04L 27/30; H04L 27/20; H04B 15/00; H04L 27/22

(52) U.S. Cl. 375/146; 375/147; 375/295; 375/308; 375/329

(57) ABSTRACT

A communication transmitter apparatus includes a reference clock generator, a harmonic signal generator, and a modulator. The reference clock generator provides a reference clock signal that has a prescribed frequency. The harmonic signal generator provides one or more harmonic signals of the reference clock signal. The modulator modulates the one or more harmonic signals with an input signal to generate an output signal. A corresponding communication receiver apparatus receives the output signal of the communication transmitter apparatus.

### TECHNICAL FIELD

This patent application relates generally to communication apparatus and, more particularly, to high data-rate (HDR) ultra-wideband (UWB) communication apparatus.

### BACKGROUND

The proliferation of wireless communication devices in unlicensed spectrum and the ever increasing consumer demands for higher data bandwidths has placed a severe strain on those frequency spectrum bands. Examples of the unlicensed bands include the 915 MHz, the 2.4 GHz Industrial, Scientific and Medical (ISM) band, and the 5 GHz Unlicensed National Information Infrastructure (UNII) bands. New devices and new standards emerge continually, for example, the IEEE 802.11b, IEEE 802.11a, IEEE 802.15.3, HiperLAN/2 standards. The emergence and acceptance of the standards has placed, and continues to place, a further burden on those frequency bands. Coexistence among the many systems competing for radio-frequency (RF) spectrum is taking on an increasing level of importance as consumer devices proliferate.

Persons skilled in the art know that the available bandwidth of the license-free bands (and the RF spectrum available generally) constrains the available data bandwidth of wireless systems. Furthermore, data-rate throughput capability varies proportionally with available bandwidth, but only logarithmically with the available signal-to-noise ratio. Hence, to transmit increasingly higher data rates within a constrained bandwidth requires the use of complex communication systems with sophisticated signal modulation schemes.

The complex communication systems typically need significantly increased signal-to-noise ratios, thus making the higher data rate systems more fragile and more easily susceptible to interference from other users of the spectrum and from multipath interference. The increased susceptibility to interference aggravates the coexistence concerns noted above. Furthermore, regulatory limitations within given RF bands constrain the maximum available signal-to-noise ratio and therefore place a limit on the data-rate throughput of the communication system. A need therefore exists for a high data-rate communication apparatus and system that can readily coexist with other existing wireless communication systems, and yet can robustly support relatively high data-rates in a multipath environment.

### SUMMARY

One aspect of the invention relates to communication apparatus, such as communication transmission apparatus and communication receiver apparatus. In one embodiment, a communication transmitter apparatus according to the invention includes a reference clock generator, a harmonic signal generator, and a modulator. The reference clock generator provides a reference clock signal that has a prescribed frequency. The harmonic signal generator provides one or more (i.e., at least one) harmonic signals of the reference clock signal. The modulator modulates the one or more of harmonic signals with an input signal to generate an output signal.

In another embodiment, a communication receiver apparatus according to the invention includes a reference clock generator, a harmonic signal generator, and a demodulator. The reference clock generator provides a reference clock signal. The reference clock signal has a prescribed frequency. The harmonic signal generator provides one or more (i.e., at least one) harmonic signals. The one or more harmonic signals are harmonics of the reference clock signal. The demodulator uses a signal derived from the one or more harmonic signals to demodulate an input signal of the communication receiver apparatus.

Another aspect of the invention relates to methods of receiving and transmitting communication signals. In one embodiment, a method according to the invention of generating a transmission signal includes generating a reference clock signal. The reference clock signal has a prescribed frequency. The method further comprises generating one or more (i.e., at least one) harmonic signals. The one or more harmonic signals constitute harmonics of the reference clock signal. The method also includes modulating the one or more harmonic signals with an input signal to generate the transmission signal.

In another embodiment, a method according to the invention of receiving a communication signal includes generating a reference clock signal that has a prescribed or desired frequency. The method also includes generating one or more (i.e., at least one) harmonic signals of the reference clock signal. The method further comprises demodulating the communication signal by using a signal derived from the one or more harmonic signals to generate an output signal.

### BRIEF DESCRIPTION OF THE DRAWINGS

The appended drawings illustrate only exemplary embodiments of the invention and therefore should not be considered as limiting its scope. The disclosed inventive concepts lend themselves to other equally effective embodiments. In the drawings, the same numeral designators used in more than one drawing denote the same, similar, or equivalent functionality, components, or blocks.

FIG. 1 shows several power spectral density (PSD) profiles in various embodiments according to the invention.

FIG. 2 illustrates exemplary signal waveforms corresponding to a high data-rate UWB apparatus.

FIG. 3 depicts an exemplary embodiment of a high data-rate UWB transmitter according to the invention.

FIG. 4 shows exemplary waveforms corresponding to a high data-rate UWB transmitter according to the invention.

FIG. 5 illustrates an exemplary embodiment of high data-rate UWB receiver according to the invention.

FIG. 6 depicts exemplary waveforms corresponding to a high data-rate UWB receiver according to the invention.

FIG. 7 shows the timing relationship among various signals in a high data-rate UWB transmitter according to the invention.

FIG. 8 illustrates exemplary desired or prescribed PSD profiles that correspond to the two modes of operation in illustrative embodiments according to the invention.

FIG. 9 shows a PSD profile for an exemplary embodiment of the invention that uses higher-order harmonics.

FIG. 10 illustrates an illustrative PSD profile in an exemplary embodiment according to the invention.

FIG. 11A shows one cycle of an exemplary output signal of a transmitter in a UWB communication apparatus according to the invention.

FIG. 11B illustrates one cycle of another exemplary output signal of a transmitter in a UWB communication apparatus according to the invention.

FIG. 12 depicts a timing relationship between several signals in an exemplary embodiment according to the invention.

FIG. 13 shows several PSD profiles for an illustrative embodiment according to the invention.

FIG. 14 illustrates several PSD profiles for other exemplary embodiments according to the invention.

FIG. 15 depicts PSD profiles for other illustrative embodiments according to the invention.

FIG. 16 shows PSD profiles for other exemplary embodiments of communication systems or apparatus according to the invention.

FIG. 17 illustrates an exemplary embodiment according to the invention of a communication system that incorporates mode switching.

FIG. 18 depicts illustrative chipping sequences for use in communication systems and apparatus according to the invention.

FIG. 19 shows an exemplary embodiment 19 of a differential receiver according to the invention.

FIG. 20 illustrates a set of offset quadrature phase shift keyed (OQPSK) UWB signals in an exemplary embodiment according to the invention.

FIG. 21 depicts a set of chipping signal waveforms in an exemplary embodiment according to the invention.

### DETAILED DESCRIPTION

This invention contemplates high data-rate communication apparatus and associated methods. Communication apparatus according to the invention provide a solution to the problems of coexisting communication systems, and yet providing relatively high data-rates. Note that wireless or radio communication systems according to the invention provide relatively high data-rates in “hostile” propagation environments, such as multipath environments. Furthermore, as described below, one may apply the inventive concepts described here to land-line communication systems, for example, communication systems using coaxial cables, or the like.

In one exemplary embodiment according to the invention, a high data-rate UWB data transmission system uses a binary phase shift keying (BPSK) modulation of a carrier frequency, known to persons of ordinary skill in the art with the benefit of the description of the invention. One obtains the power spectral density (PSD) at frequency f of such a system as:

$${P}_{n} = \frac{2 {nf}_{c}^{2}}{π} \cdot {\vert \frac{sin ( \frac{π f}{{f}_{c}} )}{{f}^{2} - {( {nf}_{c} )}^{2}} \vert}^{2} ,$$

where f_{c} denotes the reference clock frequency, and n represents the number of carrier cycles per chip. In other words,

$$n = \frac{\# of carrier cyles}{1 chip} .$$

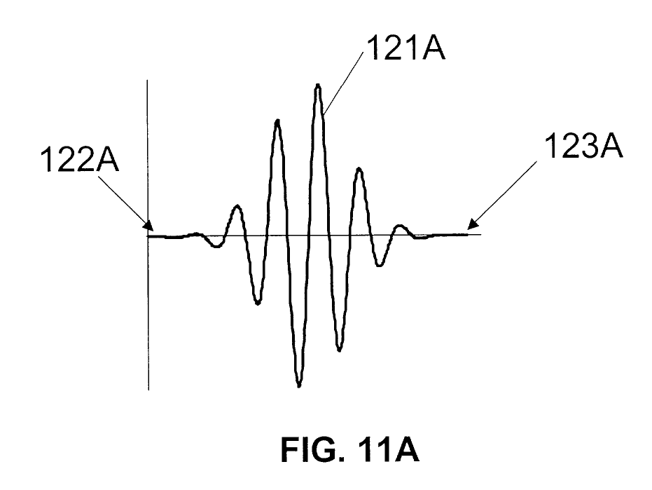

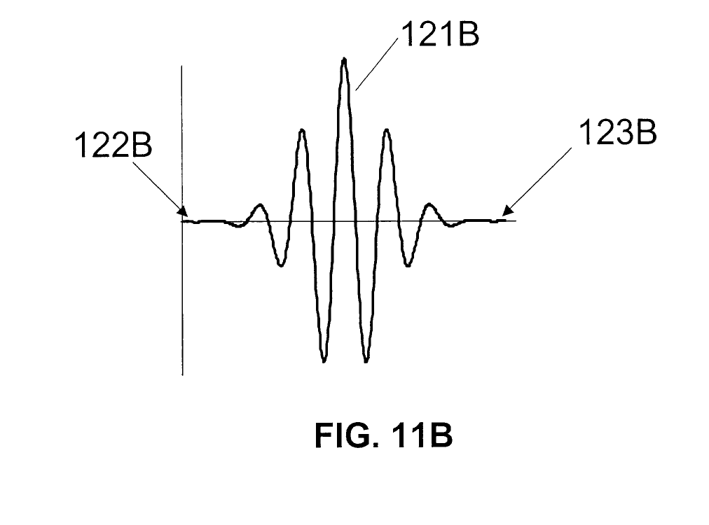

A chip refers to a signal element, such as depicted in FIG. 11A or FIG. 11B. Put another way, a chip refers to a single element in a sequence of elements used to generate the transmitted signal. The transmitted signal results from multiplying the sequence of chips (the chip sequence) by a spreading code, i.e., the code that spreads the transmitted signal spread over a relatively wide band. Multiple chips in proportion to a desired energy level per bit encode each data bit.

In this embodiment, the modulation chipping rate is commensurate with the carrier frequency. Put another way, n is a relatively small number. In illustrative embodiments, for example, n has a value of less than ten, such as 3 or 4. In other illustrative embodiments, one may use n in the range of 1 to 500, or 1 to 42. Using the latter range of values of n, one may achieve a UWB bandwidth of 500 MHz or greater, up to a frequency limit of approximately 10.6 GHz, as prescribed in the Federal Communications Commission's (FCC) Part 15 rules.

As persons of ordinary skill in the art with the benefit of the description of the invention understand, one may use other positive integer values of n, as desired. Generally speaking, the choice of the values of n depend on one's definition of ultra-wideband. Depending on a desired bandwidth, one may select appropriate values of n, as desired.

The value of n (rounded up to an integer value) corresponds to approximately the desired center operating frequency divided by one half the desired bandwidth. In other words,

$$\begin{matrix}\begin{matrix}n = ⌈ \frac{{f}_{o}}{\frac{Δ f}{2}} ⌉ , \\ or\end{matrix} \\ n = ⌈ \frac{2 {f}_{o}}{Δ f} ⌉ ,\end{matrix}$$

where fₒ and Δf denote, respectively, the center operating frequency and the desired bandwidth. For instance, the above example of the FCC's definition of UWB results in values of n in the range of 1 to 42. More specifically, a 500-MHz-wide UWB system operating below (by half the bandwidth) the current FCC Part 15 limit frequency of 10.6 GHz results in:

$$n = ⌈ \frac{10.6 - ( \frac{0.5}{2} )}{( \frac{0.5}{2} )} ⌉ ,$$

or

n=┌41.4┐=42.

The FCC has also allowed UWB signals of at least a 500-MHz bandwidth in the frequency range of 22-29 GHz, which corresponds to an upper value of n=116,000. Thus, persons skilled in the art with the benefit of the description of the invention may choose virtually any appropriate ranges of values for n, depending on the performance and design specifications and requirements for a given application. Note that generally the signal bandwidth varies inversely with the value of n.

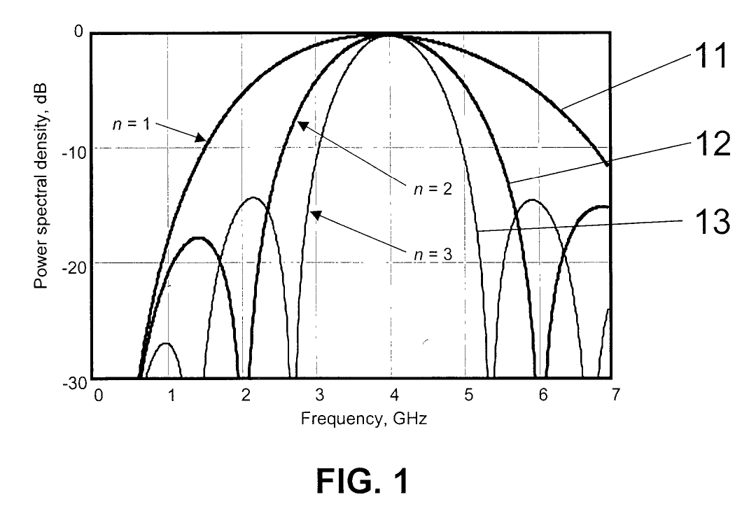

FIG. 1 illustrates several PSD profiles for various values of n (the number of carrier cycles per chip). PSD 11 corresponds to n=1, whereas PSD 12 and PSD 13 correspond, respectively, to n=2 and n=3. Note that as the value of n increases, the bandwidth of the modulated signal decreases. Note further that, in a UWB system that one wishes to constrain to a predetermined maximum PSD (e.g., PSD characteristics prescribed by a regulatory authority), one seeks to achieve as flat a spectrum as possible in order to maximize the total transmitted power in a predetermined bandwidth.

In such a system, one likewise seeks to choose a transmission bandwidth independent of the modulation rate in order to maximize the total transmitted power. As persons of ordinary skill in the art appreciate, in conventional BPSK systems, the PSD is not flat even in the highest bandwidth case, where n=1. Furthermore, the bandwidth depends on the chip rate, as manifested by the parameter n. The dependence of the bandwidth on the parameter n may be undesirable for a variety of reasons, such as difficulty or failure to meet prescribed regulatory or design specifications.

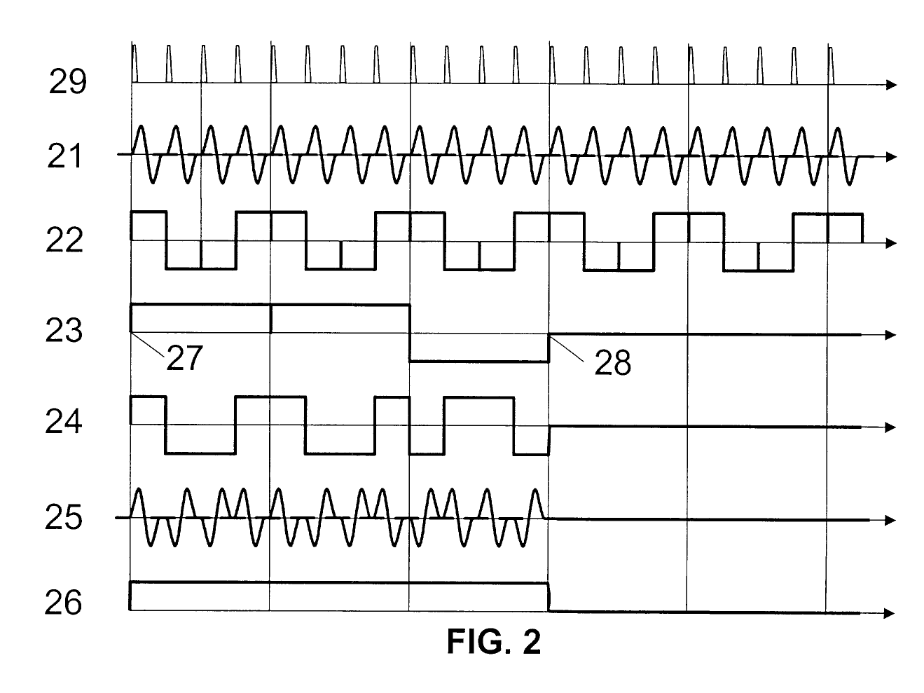

For illustrative purposes, FIG. 2 depicts various signals corresponding to a BPSK transmission system. Carrier signal 21 may include only a fundamental frequency. Alternatively, rather than a continuous sine-wave signal, carrier signal 21 may include other waveforms, as described below. FIG. 2 also shows a pseudo-random noise (PN) sequence 22. Note that the waveforms in FIG. 2 correspond to a communication system with one chip per RF cycle (i.e., n=1), and 4 chips per data bit.

The third waveform in FIG. 2 corresponds to data bits 23. Beginning at time 27 and ending at time 28, PN sequence 22 codes data bits 23. The coding of data bits 23 results in signal 24. Signal 24 modulates carrier 21 to generate modulated signal 25. Signal 26 acts a gating signal. Put another way, the communication system transmits modulated signal 25 while the gating signal 26 is active (during the active portion of signal 26). Modulated signal 25 has a spectrum substantially the same as spectrum 11 in FIG. 1 (i.e., the case where the parameter n has a value of unity).

One may determine the data-rate or data throughput of the communication system from various system parameters. For example, assume that the carrier signal has a frequency of 4 GHz, and that the system operates with one chip per RF cycle (i.e., n=1) and 4 chips per data bit. Given those parameters, persons of ordinary skill in the art who have the benefit of the description of the invention readily appreciate that the system provides a 1-gigabit-per-second (Gb/s) data rate.

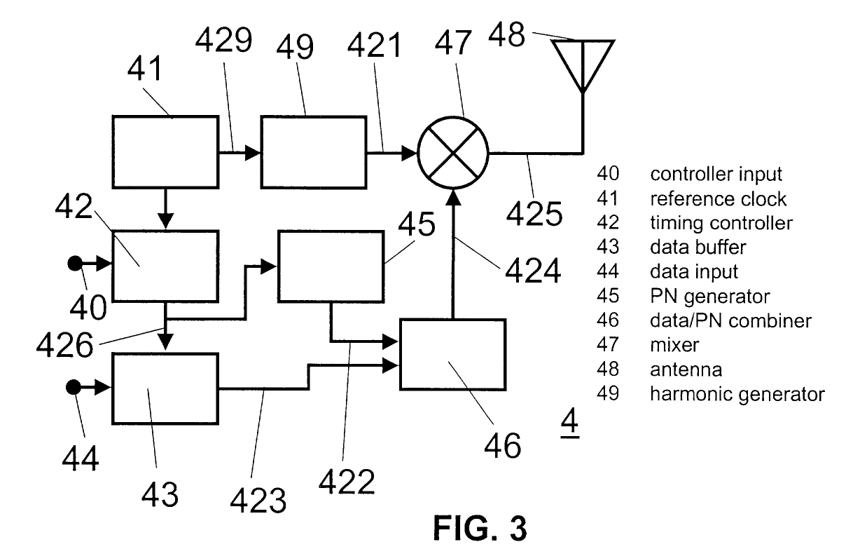

One exemplary embodiment of a high data-rate UWB system according to the invention includes a high data-rate UWB transmitter and a high data-rate UWB receiver. FIG. 3 shows an exemplary embodiment of high data-rate UWB transmitter 4 according to the invention.

Transmitter 4 includes reference clock 41 (a reference clock generator), timing controller 42, data buffer 43, PN generator 45 (a pseudo-random noise sequence generator), data/PN combiner 46, mixer 47, antenna 48, and harmonic generator 49. Reference clock 41 generates a signal with a desired frequency. The frequency of reference clock 41 corresponds to a carrier frequency for transmitter 4. Thus, the frequency of reference clock 41 corresponds to the desired carrier frequency. One may implement reference clock 41 in a number of way and by using various techniques that fall within the knowledge of persons skilled in the art with the benefit of the description of the invention.

Reference clock 41 couples to harmonic generator 49. Based a clock signal it receives from reference clock 41, harmonic generator 49 generates one or more harmonics of the carrier frequency (the frequency of clock reference 41). For example, given a clock frequency f_{c}, a second harmonic signal at the output of harmonic generator 49 has a frequency 2·f_{c}, and so on, as persons skilled in the art with the benefit of the description of the invention understand. Harmonic generator 49 generates the one or more of harmonics synchronously with respect to the reference clock (i.e., the one or more harmonics are synchronized to the reference clock).

Note that one may realize harmonic generator 49 in a number of ways, for example, comb line generators, as persons of ordinary skill with the benefit of the description of the invention understand. As another example, one may use phase-locked loops, as desired. As other examples, one may employ an oscillator followed by digital divider circuitry. By dividing a signal of a given frequency by various integers, one may obtain the one or more harmonics. In connection with such an implementation, one may use fractional-N synthesizers, as desired.

Furthermore, one may use a variety of circuitry and techniques to synchronize the one or more harmonics to the reference clock. Such circuitry and techniques fall within the knowledge of persons of ordinary skill in the art who have the benefit of the description of the invention. As an example, a comb line generator may provide synchronization of the one or more harmonics to the reference clock.

Mixer 47 receives the one or more harmonics from harmonic generator 49. Mixer 47 mixes the one or more harmonics of the carrier frequency with a signal (described further below) that it receives from data/PN combiner 46. Mixer 47 provides the resulting signals to antenna 48. Antenna 48 propagates those signals into the transmission medium. In illustrative embodiments, antenna 48 may constitute a wide-band antenna.

Examples of wide-band antennas include those described in the following patent documents: U.S. Pat. No. 6,091,374; U.S. patent application Ser. No. 09/670,792, filed on Sep. 27, 2000; U.S. patent application Ser. No. 09/753,244, filed on Jan. 2, 2001; U.S. patent application Ser. No. 09/753,243, filed on Jan. 2, 2001; and U.S. patent application Ser. No. 09/077,340, filed on Feb. 15, 2002; and U.S. patent application Ser. No. 09/419,806, all assigned to the assignee of the present application. Furthermore, one may use wide-band horn antennas and ridged horn antennas, as desired. As yet another alternative, one may employ a differentially driven wire segment as a simple, effective, wide-band radiator. In addition, one may use other suitable wide-band antennas, as persons of ordinary skill in the art who have the benefit of the description of the invention understand.

Note that some antennas are of the “constant gain with frequency” types, and result in systems that have frequency dependent propagation characteristics. Other antennas, for example, horn antennas, are of the “constant aperture” variety, and produce frequency-independent propagation behavior. To use harmonics with relatively high frequencies, exemplary embodiments according to the invention use “constant aperture with frequency” antennas, although one may employ other types of antenna, as persons of ordinary skill in the art who have the benefit of the description of the invention understand.

Reference clock 41 also couples to timing controller 42. Timing controller 42 clocks the data in data buffer 43. Note that timing signals from timing controller 42 also clock PN generator 45. Data buffer 43 receives its input data from data port 44. A PN sequence from PN generator 45 modulates the data from data buffer 43 by using data/PN combiner 46, in a manner that persons of ordinary skill in the art with the benefit of the description of the invention understand. PN encoded data from data/PN combiner 46 modulates the one or more harmonics in mixer 47. In illustrative embodiments according to the invention, data/PN combiner 46 constitutes an exclusive-OR (XOR) gate, although one may use other suitable circuitry, as persons of ordinary skill in the art with the benefit of the description of the invention understand.

In illustrative embodiments, one may use filters at the output of harmonic generator 49 to adjust the amplitudes of the one or more harmonics so that have substantially the same value. Note, however, that in other embodiments according to the invention, one may use unequal amplitudes, as desired. By using unequal amplitudes, one may control the amount of energy in the transmitted signals at particular frequencies or bands of frequencies.

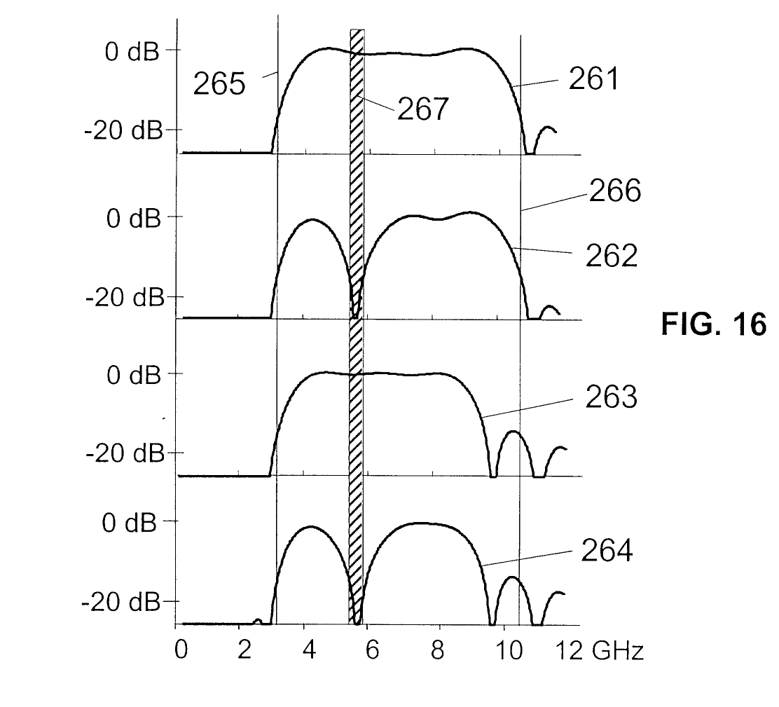

Unequal amplitudes affect the amount of energy in various parts of the corresponding PSD profile. For example, reduced (or eliminated) amplitudes result in reduced energy in corresponding frequency bands. (FIG. 16 shows an example of such a system, where one desires to radiate less energy in band 267 so as to improve coexistence with radio systems operating within that band.)

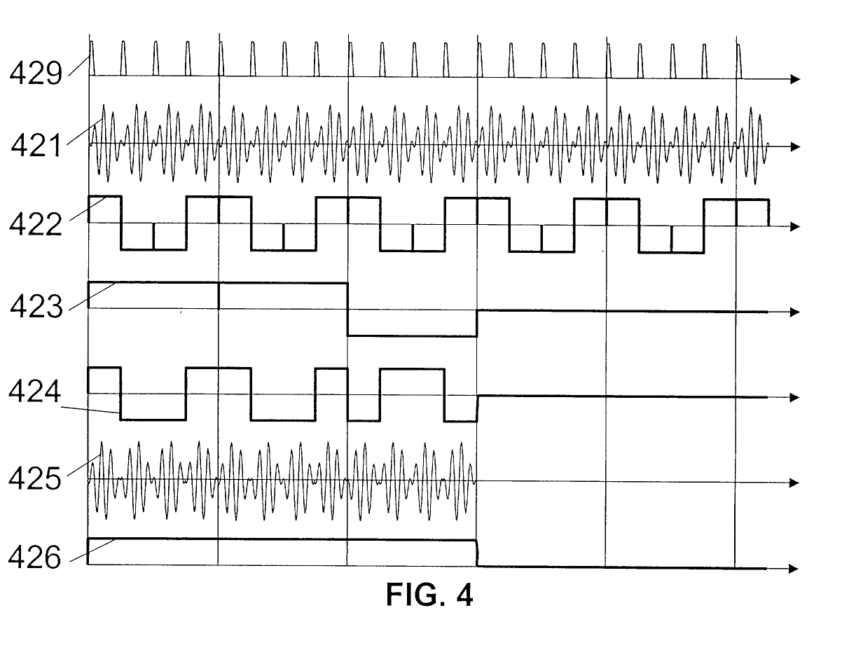

FIG. 4 illustrates exemplary waveforms corresponding to high data-rate UWB transmitter 4. Signal 421 corresponds to the output of harmonic generator 49. Signal 422 corresponds to a relatively short PN sequence of 4 chips per data bit. Signal 423 illustrates a relatively short data sequence. Signal 429, shown to provide more timing detail for transmitter 4, constitutes the output signal of reference clock 41.

Persons of ordinary skill in the art who have the benefit of the description of the invention appreciate that, depending on the application, chip sequences longer than 4 chips per bit may be desirable. For example, one may use such chip sequences when the transmission medium constitutes an RF channel with substantial multipath, or when one desires more energy per data bit (at the cost of the data throughput rate).

Generally, one may use as few as one chip per bit to obtain the maximum data rate, as desired. Furthermore, one may employ as many as tens of thousands of chips per bit in order to obtain “integration” gain at the cost of data rate. Thus, the range for the number of chips per bit may be very broad, as desired, depending on the design and performance specifications for a particular application, as persons skilled in the art understand. For example, in illustrative embodiments according to the invention, one may generally use 1 to 200 chips per bit, as desired. As another example, in embodiments that comply with IEEE 802.15, one typically desires data rates as high as 480 Mbps, corresponding to a few chips per bit, and as low as 11 Mbps, implying approximately several hundred chips per bit.

Persons of ordinary skill in the art who have the benefit of the description of the invention appreciate that the number of the PN chips per data bit is a measure of coding gain useful in mitigating against interference and against multipath impairments. Thus, using a larger number of chips per data bit provides one mechanism for reducing the effects of interference and multipath.

As noted above, one may implement data/PN combiner 46 using an exclusive-OR gate. Signal 424 depicts the result of an exclusive-OR operation on signals 422 and 423. Modulated RF signal 425 results from combining signal 421 and signal 424 in mixer 47. Timing signal 426 depicts the transmission time for the sequence of data bits 423.

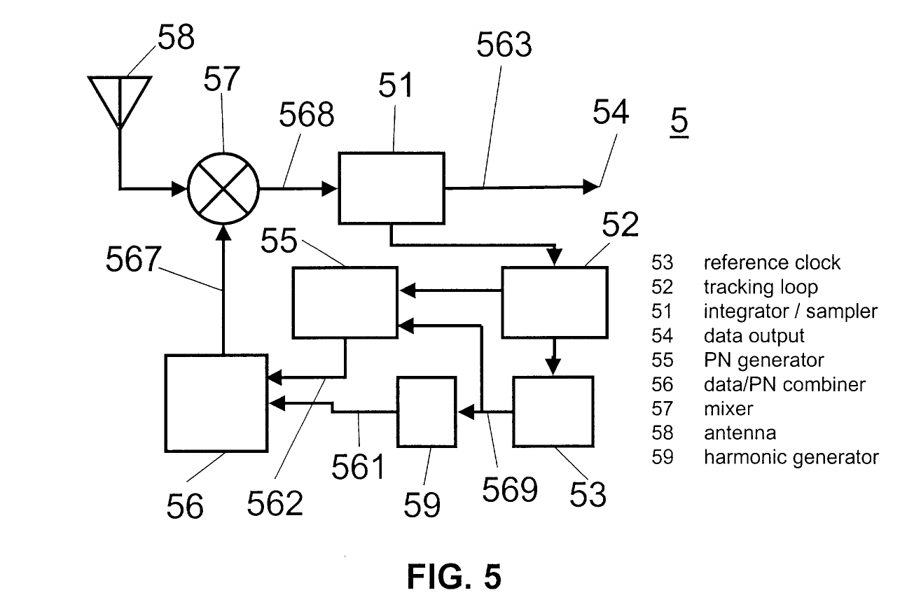

FIG. 5 illustrates an exemplary embodiment of high data-rate UWB receiver 5 according to the invention. Receiver 5 includes reference clock 53, tracking loop 52, integrator/sampler 51, PN generator 55, data/PN combiner 56, mixer 57, antenna 58, and harmonic generator 59. Similarly named blocks and components in receiver 5 may have similar structure and operation as the corresponding blocks and components in transmitter 4 depicted in FIG. 3.

Referring to FIG. 5, in high data-rate UWB receiver 5, receiving antenna 58 couples received modulated signal 425 (shown as the signal coupled to the transmission medium in FIG. 3, with an exemplary waveform depicted in FIG. 4) to mixer 57. Mixer 57 supplies its output signal to integrator/sampler 51. Integrator/sampler 51 integrates the output signal of mixer 57 to deliver recovered data bit signal 563 as data output 54.

Mixer 57 also receives template signal 567. Data/PN combiner 56 generates template signal 567 from an output of PN generator 55 and harmonic generator 59. In illustrative embodiments according to the invention, data/PN combiner 56 constitutes an exclusive-OR (XOR) gate, although one may use other suitable circuitry, as persons of ordinary skill in the art with the benefit of the description of the invention understand. Harmonic generator 59 operates in a similar manner as harmonic generator 49 in FIG. 3, and may have a similar structure or circuitry.

A tracking loop 52, well known in the art, controls reference clock 53 and PN generator 55. Tracking loop 52 controls the timing of PN generator 55 for proper signal acquisition and tracking, as persons of ordinary skill in the art with the benefit of the description of the invention understand. Reference clock 53 provides reference clock signal 569 to PN generator 55 and harmonic generator 59.

Note that one may implement tracking loop 52 in a variety of ways, as desired. The choice of implementation depends on a number of factors, such as design and performance specifications and characteristics, as persons skilled in the art understand. Tracking loop 52 operates in conjunction with template signal 567 to provide a locking mechanism for receiving a transmitted signal (template receiver or matched template receiver), as persons skilled in the art who have the benefit of the description of the invention understand.

Mixer 57 mixes the signal received from antenna 58 with template signal 567 to generate signal 568. Integrator/sampler 51 integrates signal 568 to generate recovered data signal 563. Integrator/sampler 51 drives tracking loop 52, which controls signal acquisition and tracking in high data-rate UWB receiver 5.

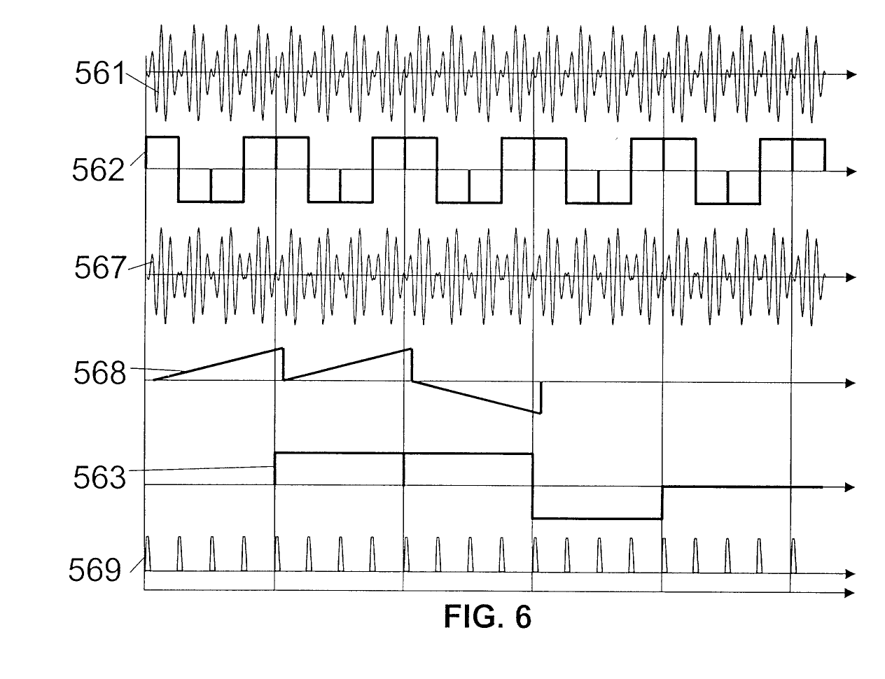

FIG. 6 illustrates exemplary waveforms corresponding to high data-rate UWB receiver 5. Signal 562 constitutes the output of PN generator 55. Signal 561 corresponds to the output of harmonic generator 59, whereas signal 567 is the output signal of data/PN combiner. Signal 568 constitutes the output signal of mixer 57, which feeds integrator/sampler 51. Signal 563 is the output signal of integrator/sampler 51. Finally, signal 569, shown to provide more timing detail for receiver 5, constitutes the output signal of reference clock 53.

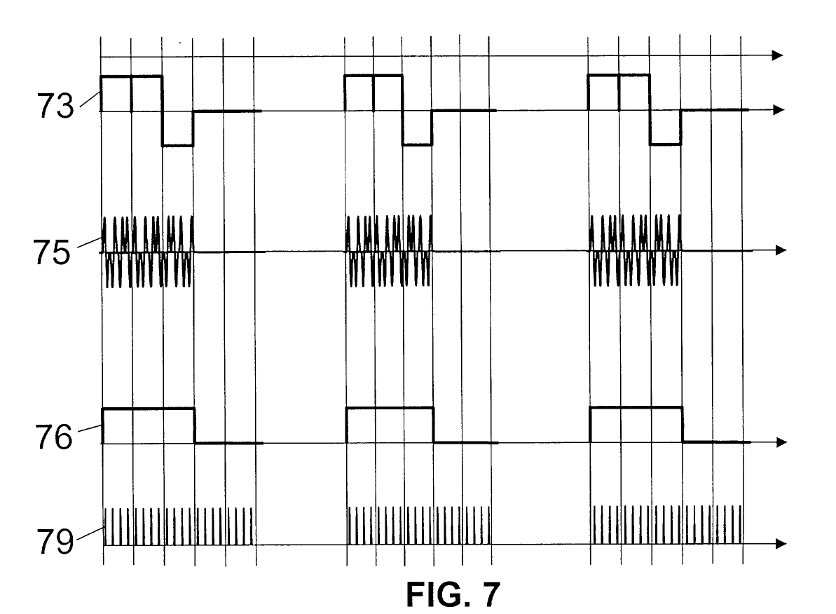

FIG. 7 shows further details of the timing relationship among various signals in the high data-rate UWB transmitter 4. Waveform 75 corresponds to the signals in the transmission medium (i.e., propagated from antenna 48). Waveform 76 shows the transmission periods, i.e., periods of time during which transmitter 4 transmits. Finally, waveform 73 illustrates data bit stream 73 during transmission periods 76. Waveform 79 depicts the clock tick marks for timing reference with respect to the other waveforms in FIG. 7.

In other embodiments according to the invention, one may operate high data-rate UWB transmitter 4 in either of two modes, depending on a selected or prescribed parameter. Each mode may generate a particular or prescribed PSD profile by using particular or prescribed harmonic orders (i.e., the choice of the harmonics of the carrier to use for each mode). By selecting a particular mode, one may operate transmitter 4 such that it produced output signals that conform to a particular PSD profile or meet prescribed conditions (as set forth, for example, by a regulatory authority, such as the FCC).

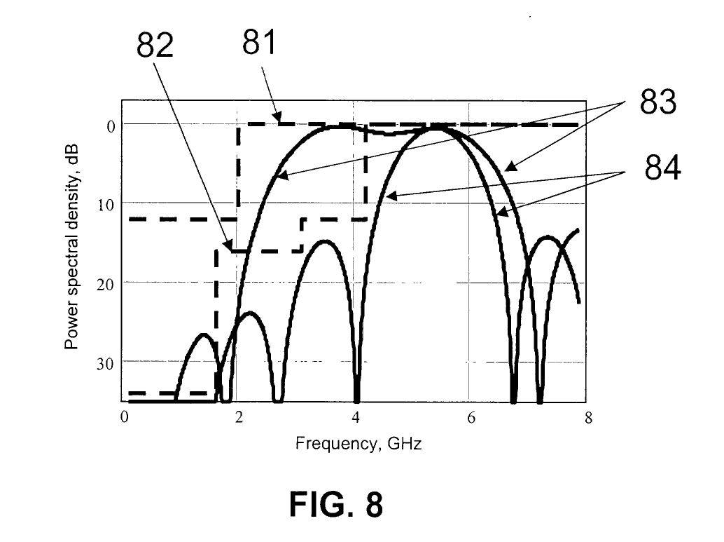

FIG. 8 depicts two exemplary desired or prescribed PSD profiles that correspond to the two modes of operation in such embodiments. A transmitter according to the invention may produce outputs that conform to a selected one of predetermined PSD amplitude profile mask 80 and predetermined PSD amplitude profile mask 81. In an embodiment of such a transmitter, the frequency of the reference clock (i.e., the frequency of reference clock 41 in FIG. 3) is approximately 1.8 GHz. Accordingly, the second and third harmonics appear at approximately 3.6 GHz and 5.4 GHz, respectively.

In a first mode of operation conforming to PSD amplitude profile mask 80, one modulates the 3.6 GHz carrier (the second harmonic of the reference clock frequency) with one chip per two RF carrier cycles. Furthermore, one modulates the 5.4 GHz carrier (the third harmonic of the reference clock frequency) with one chip per three RF cycles. In this mode of operation, the transmitter has a chipping rate of 1.8 giga-chips per second. The transmitter produces a transmitted PSD 83. Note that transmitted PSD 83 has a substantially flat shape, and conforms to PSD mask 80 (i.e., it remains under PSD mask 80).

In a second operating mode, one suppresses the second harmonic while modulating the third harmonic 1.80-GHz clock (i.e., the harmonic appearing at 5.6 GHz) at a rate of one chip per four RF cycles. As a result, the transmitter has a chipping rate of 1.35 giga-chips per second.

Note that one may implement embodiments according to the invention that include more than two operating modes, as desired. For example, one may provide a UWB apparatus that includes m operating modes, where m denotes an integer larger than unity. One may implement such a system in a variety of ways, as persons of ordinary skill in the art with the benefit of the description of the invention understand. For example, one may use a bank of selectable harmonic filters (i.e., selectable choice of which harmonic orders to use) to select any combination of one or more harmonics. Such a UWB radio apparatus may selectively avoid interference from or with other radio systems operating in the same band or bands. Note that in illustrative embodiments according to the invention, one may consider “one or more of m harmonics” as a form of modulation in addition to the polarity modulation (i.e., BPSK modulation).

Although the description above refers to the second and third harmonic, persons of ordinary skill in the art who have the benefit of the description of the invention appreciate that one may use other harmonics, as desired. Put another way, in each operating mode, one may employ additional harmonics beyond the third harmonic. Using additional harmonics increases the total transmitted power, while simultaneously conforming to the prescribed respective masks (i.e., remaining under the PSD masks).

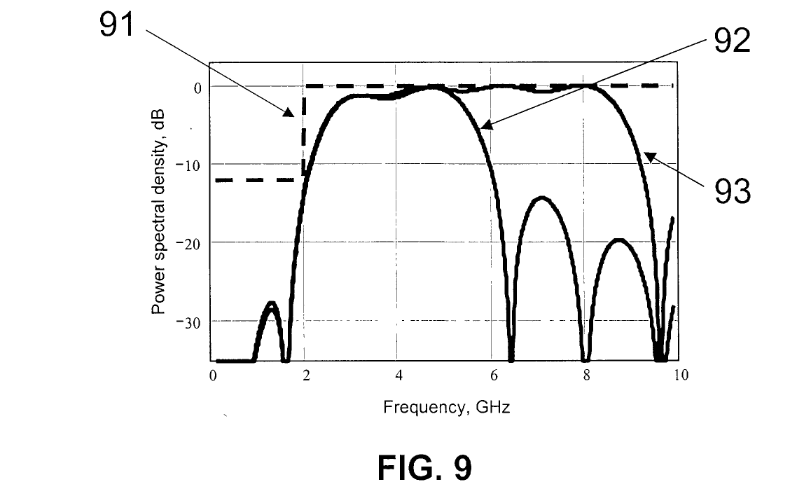

FIG. 9 shows a PSD profile for an exemplary embodiment of the invention that uses higher-order harmonics. Transmitted PSD 91 corresponds to modulated third and fourth harmonics of a 1.1-GHz reference clock. PSD 91 assumes modulation at the rate of 1.1 giga-chips per second.

If one desired more transmitted power, one may employ the third through seventh harmonics. Doing so results in transmitted PSD 93. Note that both PSD 92 and PSD 93 have substantially flat shapes. Note further that both PSD 92 and PSD 93 conform to a prescribed or desired PSD amplitude profile mask 90. Thus, by using a number of harmonics of the reference clock frequency that have an appropriate order, one may implement communication systems with particular output power profiles that conform to prescribed PSD profiles, as desired.

Note that one may use an appropriate clock reference frequency and associated harmonics to provide co-existence with other devices that use a particular RF band or spectrum. For example, in other embodiments according to the invention, the clock reference parameters and the harmonic carriers are selected so that the PSD of the high data rate UWB transmissions coexist with wireless devices operating in the 2.4 GHz ISM band and in the 5 GHz UNII bands.

More specifically, in such embodiments, the reference clock has a frequency of approximately 1.1 GHz. Furthermore, the transmitter uses as carrier frequencies modulated at the reference clock rate of approximately 1.1 GHz both the third and fourth harmonics of the reference clock frequency (i.e., 3.3 GHz and 4.4 GHz, respectively).

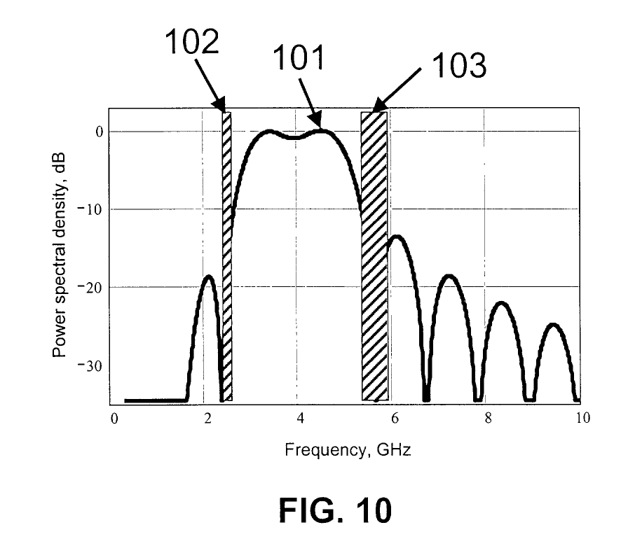

FIG. 10 shows an exemplary PSD profile for such an embodiment of the invention. Transmission PSD 101 fits between the 2.4 GHz ISM band 102 and the 5 GHz UNII bands 103, satisfying a desired level of coexistence. Note that the communication system can still support a relatively high data-rate. For example, if one uses 10 PN chips to comprise one data bit, the resulting data rate is 110 megabits per second (Mb/s).

Signal harmonics may be added with a selectable, desired, or designed degree of freedom regarding relative phase of the carriers. For example, in a communication system according to the invention that uses the third and fourth harmonics, one may generally represent the time signals x(t), the sum of the carrier harmonics, by:

x(t)=sin(2π·3·fᵣt)+sin(2π·4·fᵣt+φ),

where fᵣ represents the reference clock frequency and φ denotes a selectable or prescribed phase angle between 0 and 2π radians. Note that in exemplary embodiments according to the invention, one may realize the phase angle by using a filter, as persons of ordinary skill in the art with the benefit of the description of the invention understand.

Note that in exemplary embodiments according to the invention, one may use various values of φ, as desired, where 0≦φ≦2π. FIG. 11A illustrates one cycle of an exemplary output signal 121A of a transmitter in a UWB communication system according to the invention. Signal 121A corresponds to φ=π. Starting point 122 and ending point 123 coincide with the chip boundaries, as illustrated, for example, by signal 421 and chip signal 422 (output signal of PN generator) in FIG. 4.

Furthermore, note that one may represent output signal x(t) by using cosines, as desired. In other words,

xᵢ(t)=cos(2π·3·fᵣt)+cos(2π·4·fᵣt+φ),

where fᵣ represents the reference clock frequency and φ denotes a selectable or prescribed phase angle between 0 and 2π radians (inclusive of the end points). FIG. 11B shows one cycle of another exemplary output signal 121B of a transmitter in a UWB communication system according to the invention. Output signal 121B has starting point 122B and ending point 123B.

Persons skilled in the art with the benefit of the description of the invention appreciate that It will be appreciated that signals x(t) and xᵢ(t) constitute orthogonal signals. One may therefore use signals x(t) and xᵢ(t) to implement quadrature phase shift keying (QPSK) modulation, as described below.

Note that signals 121A and 121B have relatively small signal levels at both their starting points (i.e., 122A and 122B, respectively) and their ending points (i.e., 123A and 123B). Exemplary embodiments according to the invention switch signals ON and OFF at those relatively small signal levels. Doing so tends to avoid switching transients that with imperfect switching might alter the resulting spectrum undesirably.

In illustrative embodiments according to the invention, one may represent the harmonic carriers by a composite signal S that constitutes a summation of sinusoidal and/or cosinusoidal signals, i.e.,

S(t)=Σsin{2π·n·fᵣ·(t−s)},

where the summation extends over the range of harmonics n desired (i.e., it spans the order of the desired harmonics, from the lowest to the highest). Put another way, the composite signal S constitutes a sum of harmonic carriers over a selected range, n. Note that one may also add cosine harmonics to implement a quadrature UWB communication apparatus.

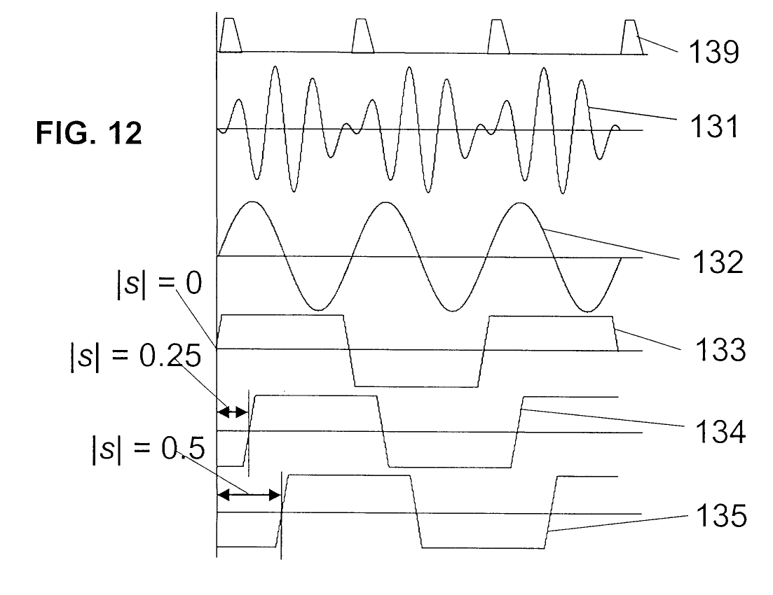

As noted above, in some embodiments, n may range from 3 to 4 (corresponding to a UWB communication apparatus operating in a desired 3.1 GHz to 5.2 GHz frequency range). FIG. 12 shows the timing relationship between several signals in such an embodiment according to the invention, with n=3. Signal 139 depicts a reference clock signal, included to facilitate presentation of the timing relationship between the various signals. Signal 131 corresponds to composite signal S, described above. Signal 132 denotes the sinusoidal signal the harmonics of which result in composite signal 131. Reference clock signal 139 corresponds to the positive-going zero-crossings of sinusoidal signal 132.

Note that time displacement s offsets the chipping signal from the carrier signal. More specifically, time displacement s appears as an offset between reference clock signal 139 (or sinusoidal signal 132) and the chipping signals.

FIG. 12 shows signals corresponding to several values of time displacement s. Each time displacement s signifies the offset between reference clock signal 139 (or sinusoidal signal 132) and one of chipping signal 133, chipping signal 134, and chipping signal 135, respectively. Specifically, chipping signal 133 corresponds to a time displacement s of zero. Chipping signal 134 and chipping signal 135 denote, respectively, time displacements of 0.25 and 0.5, respectively.

Persons of ordinary skill in the art who have the benefit of the description of the invention appreciate that, because of symmetry, negative values of s give the same results as positive values of s. Hence, the description of the invention refers to the magnitude of s, or |s|. Also, note that, although FIG. 12 illustrates the chipping sequence “101” as an example for the sake of illustration, persons skilled in the art with the benefit of the description of the invention understand that one may generally use a desired PN sequence.

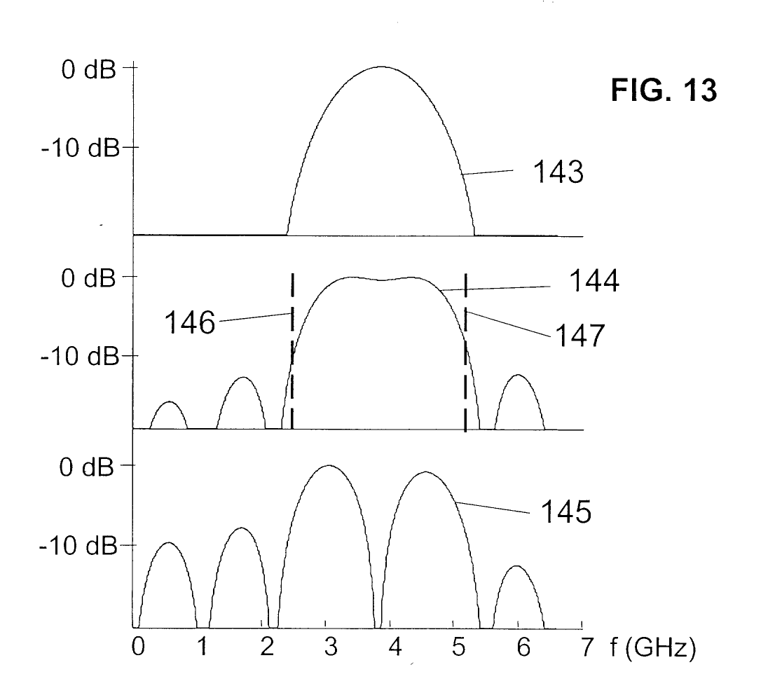

FIG. 13 illustrates several PSD profiles for an illustrative embodiment according to the invention. PSD profile 143 depicts the power spectral density of signal 131 multiplied by PN chipping sequence 133. Similarly, PSD profile 144 corresponds to the power spectral density of signal 131 multiplied by PN chipping sequence 134. Finally, PSD profile 145 illustrates the power spectral density of signal 131 multiplied by PN chipping sequence 135.

FIG. 13 also illustrates boundary 146 of the 2.4 GHz ISM band and boundary 147 of the UNII band. For two harmonics, a time displacement value |s|=0.25 provides a substantially flat PSD profile 144. Persons of ordinary skill in the art who have the benefit of the description of the invention understand, however, that one may use time displacement values (s) in a range of approximately 0.1 and approximately 0.9 to provide substantially similar PSDs for the third and fourth harmonics, as desired. In a similar manner, one may use other values of time displacement s and appropriate numbers of harmonics to implement communication systems having desired or prescribed PSDs, as desired.

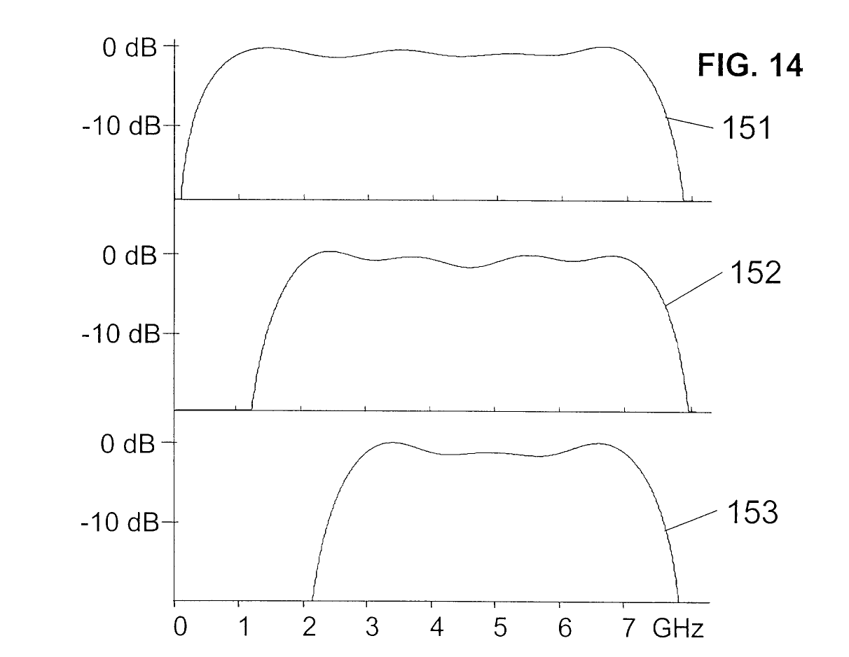

As an example, FIG. 14 depicts several PSD profiles that correspond to exemplary embodiments of the invention that use increasing numbers of harmonics. FIG. 14 includes PSD profile 151, PSD profile 152, and PSD profile 153. A substantially flat PSD profile 151 corresponds to a signal that includes the fundamental frequency through the seventh harmonic, using a time displacement value of |s|=0.375. Similarly, PSD profile 152 pertains to a signal that includes the second through the seventh harmonics, using a time displacement value of |s|=0.375. Finally, PSD profile 153 corresponds to a signal that includes the third through the seventh harmonics and uses a time displacement value of |s|=0.375.

Note that values of time displacement s between approximately 0.1 and approximately 0.9 provide substantially flat PSD profiles, similar to the PSD profiles that FIG. 14 illustrates. As noted above, using larger numbers of harmonics while conforming to PSD profiles (i.e., constrained to a maximum PSD value) results in an increase in the total transmitted or radiated power.

One may generate and implement the time displacement s in variety of ways, as persons of ordinary skill in the art who have the benefit of the description of the invention understand. For example, one may implement s as digitally derived clock shift in timing controller 42 of transmitter 4 and PN generator 55 in receiver 4. As another example, one may implement the desired time shift by using a physical delay line in the path of the digital input of mixer 47 in transmitter 4 and mixer 57 in receiver 5.

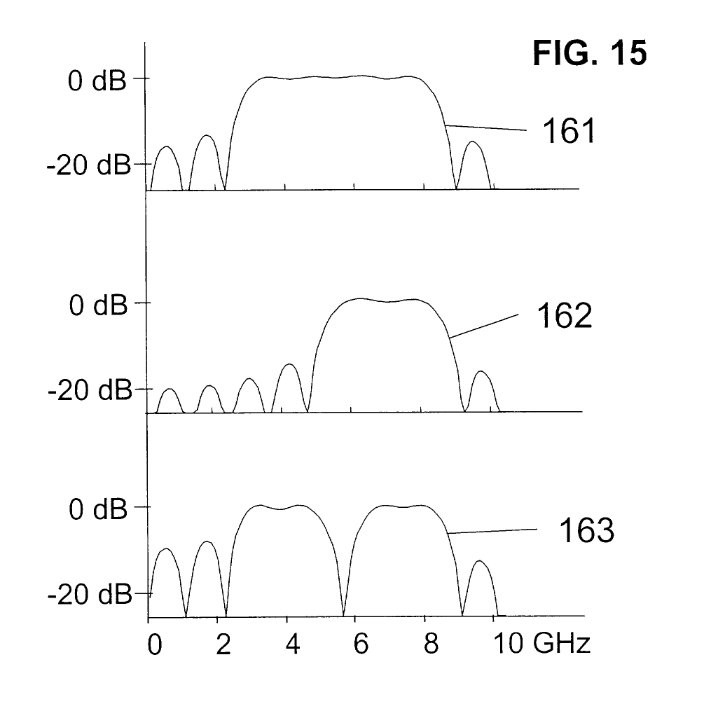

One may obtain the spectra shown in the figures by computing the Fourier Transform of the composite signal S. More specifically, where the data pulses have a generally rectangular shape and have not been filtered (e.g., chipping signal 422 in FIG. 4), one may obtain the PSD as:

$$PSD = 2 {f}_{r} {\int }_{0}^{( 1 / {f}_{r} )} {\sum }_{n = {n}_{1}}^{{n}_{2}} sin [ 2 π \cdot n \cdot {f}_{r} ( t - \frac{s}{{f}_{r}} ) ] {ⅇ}^{j 2 π f t} ⅆ t ,$$

where fᵣ denotes the chipping clock frequency, and n₁ and n₂ correspond to the order of the harmonics used (i.e., the lower and upper boundaries of the range of harmonics used). Note that one may omit selected harmonics within the range n₁ to n₂ to further shape the spectrum, as desired. FIG. 15 shows an example of applying this technique.

Referring to FIG. 15, PSD profile 161 shows the power spectral density for an embodiment of a communication system according to the invention that uses the third through seventh harmonics of a 1.1-GHz clock. In contrast, PSD profile 162 corresponds to a system that employs the fifth through the seventh harmonics. As a result, the PSD energy in the latter system lies mostly above 5 GHz.

As a third example, PSD profile 163 corresponds to a system that uses the third, fourth, sixth, and seventh harmonics. Omitting the fifth harmonic in this system results in a gap in the vicinity of 5 GHz to 6 GHz. As a result, the system may effectively coexist with systems that operate in the 5-GHz UNII band. Note that one may use filtering to readily remove energy in the side lobes shown in FIG. 15.

The PSD profiles shown in FIG. 15 correspond to illustrative embodiments of communication systems according to the invention. By judiciously employing selected harmonics together with a chosen clock frequency, one may design and implement a wide variety of communication systems with prescribed PSD profiles in a flexible manner. The choice of design parameters (e.g., clock frequency and the number and order of harmonics) depend on desired design and performance specifications and fall within the knowledge of persons of ordinary skill in the art who have the benefit of the description of the invention.

FIG. 16 shows PSD profiles for other exemplary embodiments of communication systems or apparatus according to the invention. These embodiment conform with a PSD mask in which the emissions at 3.1 GHz are at least −10 dB from the peak (marker labeled as 265 in FIG. 16). Furthermore, the mask specifies emissions at 10.6 GHz of at least −10 dB from the peak (marker denoted as 266 in FIG. 16).

UNII band 267 extends from 5.15 GHz to approximately 5.9 GHz. FIG. 16 illustrates four PSD profiles (denoted as profiles 261, 262, 263, and 264, respectively) that correspond to different choices of the order of harmonics used. All four PSD profiles correspond to a baseband chipping reference clock frequency of 1.4 GHz. Furthermore, the PSD profiles assume time displacement s of approximately 0.375 between the reference clock signal and the chipping sequences (see FIG. 13 and accompanying description for an explanation of time displacement s and its effect on PSD profiles).

As noted above, PSD profiles 261, 262, 263, and 264 denote various choices of the order of harmonics used. PSD profile 261 corresponds to a communication system that uses the 3rd through the 7th harmonics of the chipping reference clock. Thus, such a system effectively occupies the allowed bandwidth between 3.1 GHz and 10.6 GHz.

PSD profile 262 corresponds to a system that employs the 3rd, the 5th, the 6th, and the 7th harmonics of the chipping reference clock. In other words, unlike the system corresponding to PSD profile 261, it omits the fourth harmonic, which overlaps UNII band 267.

The system corresponding to PSD profile 263 uses the 3rd through the 6th harmonics of the chipping reference clock. Thus, this system omits the relatively higher frequencies by not using higher-order harmonics.

PSD profile 264 pertains to a communication system that uses the 3rd, the 5th, and the 6th harmonics of the chipping reference clock. This system omits the fourth harmonic, which overlaps UNII band 267. The system may switch its operation modes between PSD profile 261 and PSD profile 262 or, alternatively, between PSD profile 263 and PSD profile 264, as described below in detail.

Table 1 below summarizes the harmonics used in the systems corresponding to PSD profiles 261, 262, 263, and 264:

TABLE 1

| PSD Profile | Harmonic Orders Used |
|---|---|
| 261 | 3, 4, 5, 6, and 1 |
| 262 | 3, 5, 6, and 7 |
| 263 | 3, 4, 5, and 6 |
| 264 | 3, 5, and 6 |

As noted above, communication systems according to exemplary embodiments of the invention may include multi-mode operation. Such systems may switch from one mode of operation to another mode of operation based on desired or prescribed conditions or stimulus. Referring to FIG. 3, controller input signal 40 enables mode switching in transmitter 4. The state of controller input signal 40, transmitter 4 and, more specifically, timing controller 42, determines the chipping duration relative to the reference clock cycle in a manner apparent to persons of ordinary skill in the art who have the benefit of the description of the invention.

Communication systems according to the invention may perform mode switching in response to virtually any stimulus, as desired. For example, a system user may manually selection the mode and thus cause mode switching. As an alternative, the mode switching may occur in an automatic manner, for instance, in response to predetermined or selected system event.

As another example, the mode switching may occur in a semi-automatic manner, but involve manual user selection in response to an event flagged or brought to the user's attention. In other embodiments, an internal or external variable or quantity, for example, time, may control mode switching. Alternatively, a remote signal received by the communication system may switch the operating mode.

As yet another example, communications systems and apparatus according to various embodiments of the invention may switch modes in response to the detection of radio-signal energy in a desired band or bands. For example, in response to detecting the presence of radio-signal energy in the UNII bands (between 5.15 GHz and 5.85 GHz), a UWB communication apparatus or system according to the invention may switch its mode of operation so that its transmissions have a prescribed spectral content. The new mode of operation may correspond to a PSD profile that tends to eliminate, reduce, or minimize interference with any devices operating in the particular band of interest. For example, the new PSD profile may constitute PSD profile 163 in FIG. 15.

Thus, the stimulus for the switching of modes in such systems is the detection of the presence of RF signals from devices operating in a particular band or at a particular frequency or plurality of frequencies, such as UNII band devices. The response of the communication system or apparatus constitutes switching modes so as to eliminate or minimize interference, for example, by omitting the harmonic component that would result in transmitted energy in the affected frequency range or band. Such a feature provides an additional measure of coexistence with devices operating in existing radio frequency bands, such as UNII radio devices.

Note that the above examples constitute only a sampling of how one may switch the operating mode. Depending on desired design and performance specifications, one may use other techniques and mechanisms for mode switching, as persons of ordinary skill in the art who have the benefit of the description of the invention understand. Furthermore, one may apply any of these techniques to various embodiments of communication systems and apparatus according to the invention, as desired.

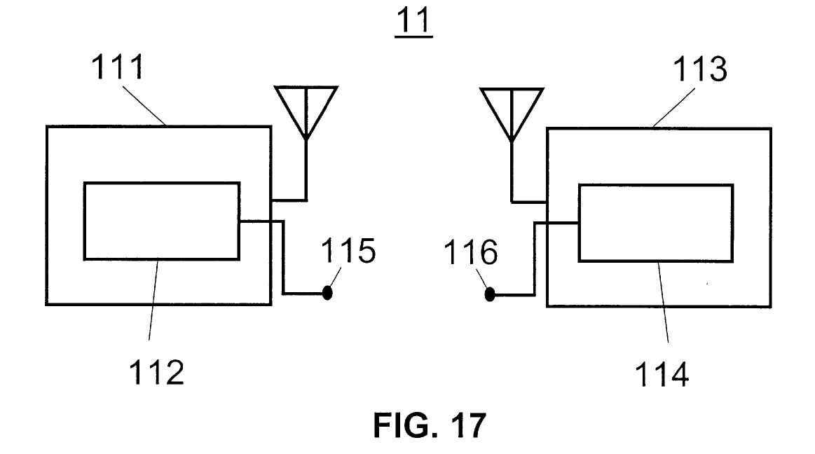

FIG. 17 shows an exemplary embodiment according to the invention of a communication system that incorporates mode switching. High data-rate UWB communication system 11 includes transceiver 111, which has internal power source 112 (e.g., a battery or other power source). System 11 also includes second transceiver 113, with its internal power source 114 (e.g., a battery or other power source). The mode switching in system 11 occurs depending on whether the system operates from its internal power sources or from an external power source (not shown explicitly in FIG. 17).

When system 11 uses internal power source 112 and internal power source 114, it may operate in a mode that conforms to a particular PSD profile, for example, PSD mask 81 in FIG. 8. This mode may correspond, for example, to system operation indoors. PSD mask 81, corresponding to indoors operation, may have more relaxed requirements because system 11 may cause less potential interference with other systems while it operates indoors.

Conversely, when system 11 uses external power (supplied through port 115 to transceiver 111 and supplied through port 116 to transceiver 113), it may operate in another mode that conforms to a different PSD profile, for example, PSD mask 82 in FIG. 8. The second mode may correspond, for example, to system operation outdoors. Thus, by switching operation modes, UWB communication systems according to the invention can meet more stringent PSD masks outdoors and yet conform to a more relaxed PSD mask while operating indoors.

To switch modes, system 11 senses the application of external power, and supplies a trigger signal to controller input 40 of the transmitter (see FIG. 3). In response, timing controller 42 and harmonic generator 49 adjust pre-determined timing parameters to generate the desired PSD profile, as described above in reference to FIG. 8. An analogous operation occurs in the receiver circuitry of the transceiver. Furthermore, a companion or corresponding transceiver similarly adjusts parameters in its transmitter circuitry and receiver circuitry in response to the particular PSD profile that the receiver circuitry receives.

Note that, although FIG. 17 shows a pair of transceivers, alternative systems may include a transceiver and a receiver, or a transmitter or receiver, as desired. Mode switching in such systems occurs using a similar technique and mechanism as described above, as persons skilled in the art with the benefit of the description of the invention understand.

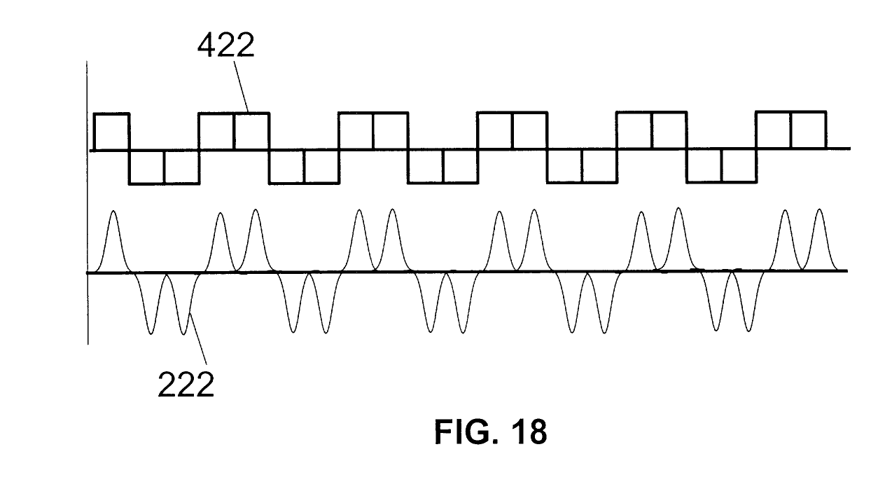

Another aspect of the invention relates to the shape of the pulses within chipping signal 422 (reproduced in FIG. 18 for convenience). Chipping signal 422 includes pulses with generally rectangular shapes. As a consequence, one may generally obtain the spectrum in the frequency domain of the chip as given approximately by the well-known sinc function,

$$\frac{sin ( x )}{x} .$$

(A chip corresponds to the distance in time between the vertical segments of signal 422, or the zero-crossings of signal 222.) The multiplication operation in mixer 47 shifts that spectrum in the frequency domain and centers a copy of the spectrum at each of the harmonic signals present in signal 421 (output signal of harmonic generator 49).

Although the description above assumes a chipping signal with pulses that generally have a rectangular shape (e.g., chipping signal 422), one may use other pulse shapes, as desired. For example, the pulses may have a more “rounded” shape.

One example of a more “rounded” pulse shape is the Gaussian impulse. Mathematically, one may represent a Gaussian impulse s(t) as:

s(t)=e^{-0.5t}^{²}^{/τ}^{²},

where t represents time, and τ denotes a parameter that defines the pulse width. One may obtain the shape of the spectrum in the frequency domain by using the Fourier transform of s(t). Mathematically, one may express the Fourier spectrum of s(t) as:

S(f)=e^{-2(πfτ)}^{²}.

Using the above relationships, one may design a pulse of width corresponding to frequency f_{B} (for example 1.1 GHz) where the magnitude of S(f) is below a reference value by a desired amount (for example, by 10 log[S(f_{B})]=−10 dB). This technique provides a design value for τ, which in turn allows one to evaluate s(t).

Note that FIG. 18 shows a Gaussian impulse as one example. One may use other shapes, as desired, as persons of ordinary skill in the art who have the benefit of the description of the invention understand. For example, one may use the trapezoidal shape of chipping signal 133, chipping signal 134, and chipping signal 135 in FIG. 12, as desired.

Furthermore, note that by shaping or filtering the pulses before mixing with a signal having a relatively high frequency (a harmonic signal), one avoids designing or shaping pulses at those relatively high frequencies. In the case of a filtered signal, one may obtain the PSD from:

$$PSD = 2 {f}_{r} {\int }_{0}^{( 1 / {f}_{r} )} p ( t ) {\sum }_{n = {n}_{1}}^{{n}_{2}} sin [ 2 π \cdot n \cdot {f}_{r} ( t - \frac{s}{{f}_{r}} ) ] {ⅇ}^{j 2 π f t} ⅆ t ,$$

where p(t) denotes the baseband filtered data signal. On example is a Gaussian filtered signal, such as one chip of chipping sequence 222 in FIG. 18. Also, note that by using multiple harmonics, one may shift the shaped pulses in the frequency domain and center the shifted versions at the desired harmonic carriers.

Although FIG. 18 shows chipping sequence 422 and chipping sequence 222 as having +1 and −1 amplitude swings, one may use other swings, as persons of ordinary skill in the art who have the benefit of the description of the invention understand. For example, one may implement chipping sequences that use +1, 0, and −1 amplitude swings, as desired.

One may use various modulation schemes and techniques in communication systems and apparatus according to the invention, as desired. For example, exemplary embodiments of the invention may use techniques analogous to the conventional quadrature phase shift keying (QPSK) systems. Other exemplary embodiments according to the invention may use techniques analogous to offset QPSK (OQPSK).

More particularly, embodiments using QPSK use two harmonic carriers, which requires two degrees of freedom so that both pairs of harmonically related signals have a quadrature relationship. Specifically, the phase difference between the two reference clocks and an additional phase delay in one of the harmonic generator lines provide the two desired degrees of freedom. A QPSK-like UWB system according to the invention with two harmonic carriers has the desired property of providing a data rate twice the data rate of a BPSK-like system, while still having an essentially flat PSD profile that conforms to prescribed or desired criteria.

Providing an additional half chip length offset between the two data streams modulating the quadrature harmonic carriers provides an OQPSK system. Such an OQPSK system has the additional desirable property of a smoothed PSD spectrum relative to the PSD profile of the QPSK system.

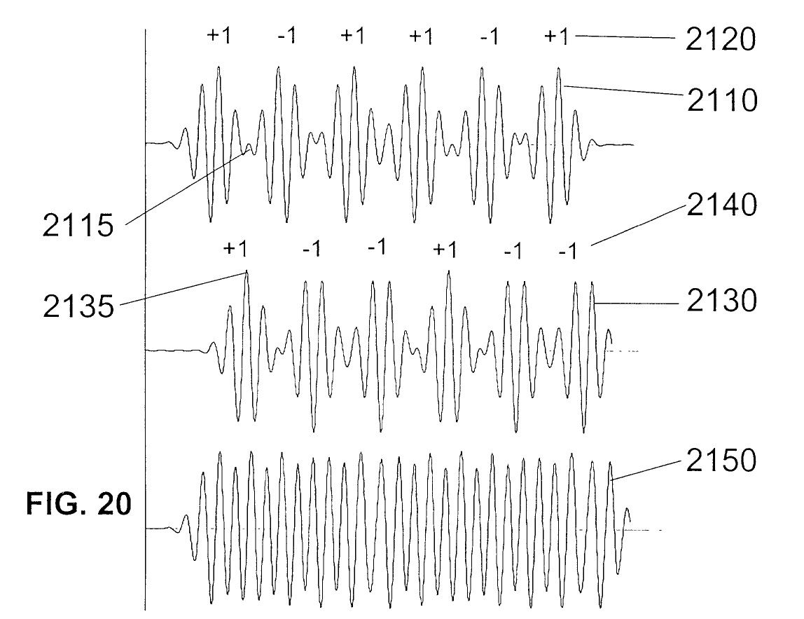

FIG. 20 shows one example of the waveforms of an OQPSK UWB signal set in an illustrative embodiment. Signal 2110 comprises sinusoidal harmonics, such as the signal shown in FIG. 11A, while signal 2130 comprises cosinusoidal harmonics, like the signal FIG. 11B illustrates. Data stream 2120 modifies the polarity of signal 2110, and data stream 2140 modifies the polarity of signal 2130, independent of data signal 2120.

The signal 2130 is furthermore shifted in time to the right of signal 2110 so that the maximum envelope value 2135 of signal 2130 substantially corresponds with the minimum envelope value 2115 of signal 2110. Additionally, to maintain quadrature, the zero-crossings of signal 2110 correspond to the respective signal peaks of signal 2130. Conversely, the zero-crossings of signal 2130 correspond to the respective peaks of signal 2110.

Signal 2150 represents the sum of quadrature signals 2110 and 2130. Persons of ordinary skill in the art with the benefit of the description of the invention appreciate that the peak-to-average value of the composite signal is smaller than the peak-to-average values of either signal 2110 or signal 2130. This property results in a smoother PSD profile, and enables RF transmissions at a power level that requires less ‘safety’ margin to the regulatory limit levels.

In other embodiments according to the invention, one may use a differential phase shift keying (DPSK) scheme. One may modify a transmitter according to the invention, for example, transmitter 4 in FIG. 3, to generate DPSK signals, as persons of ordinary skill in the art who have the benefit of the description of the invention understand. Transmitter 4 generates DPSK signals as follows. Referring to FIG. 3, transmitter 4 receives data at data input 44. Transmitter 4 encodes the data differentially, similar to conventional DPSK. More specifically, transmitter 4 encodes the data as changes in the bit stream.

For example, suppose the sequence starts with a binary “1” bit. If the next bit is a “1,” it indicates that transmitter 4 had sent a “0” previously (no change). On the other hand, if a “0” follows the original “1,” then transmitter 4 encodes a “1.” Thus, transmitter 4 encodes changes from 1 to −1 (or −1 to 1) as binary “1”s. Conversely, transmitter 4 encodes no bit-to-bit change (e.g., 1 followed by 1, or −1 followed by −1) as binary “0”s. As the above description makes evident, to transmit m bits, one transmits m+1 bits (a starting bit, followed by m bits of data), because the changes in the input data bits encode the data.

Referring to FIG. 3, data buffer 43 may perform the differential encoding described above. PN generator 45 generates chip sequences associated with a delay or time period D that equals the number of chips for a single data bit. The time delay D may be one chip time in one exemplary embodiment, and may constitute a coded sequence of bits in another illustrative embodiment (for example, D may be the number of chips associated with a single data bit). Put another way, one may use a per-chip (time period between starts of two chips) or per-bit (time period between the starts of two bits) time delay D. Regardless of the choice of time delay D, one keeps D constant for that system.

In exemplary embodiments according to the invention, one may generate chip sequences by using Barker codes or sequences. Each chip sequence is equal in length to one of the known Barker sequences. Preferably, transmitter 4 uses Barker sequences of length 13, 11, or 7, but as persons of ordinary skill in the art who have the benefit of the description of the invention understand, one may use other Barker sequences to provide chip sequences, as desired. Table 2 below lists the known Barker codes:

TABLE 2
THE KNOWN BARKER CODES

| Length | Code Sequence |
|---|---|
| 2 | 1 −1 or 1 1 |
| 3 | 1 1 −1 |
| 4 | 1 −1 1 1 or −1 −1 1 |
| 5 | 1 1 1 −1 1 |
| 7 | 1 1 1 −1 −1 1 −1 |
| 11 | 1 1 1 −1 −1 −1 1 −1 −1 1 −1 |
| 13 | 1 1 1 1 1 −1 −1 1 1 −1 1 −1 1 |

As persons skilled in the art understand, the reverse of the code sequences in Table 2 also constitute Barker codes. Furthermore, the inverse of the listed code sequences (i.e., code sequences obtained by replacing 1 with −1 and vice-versa) are Barker codes.

Note that, rather than using Barker codes, one may use other types of code, as persons of ordinary skill in the art who have the benefit of the description of the invention understand. For example, one may use Kasami codes, as desired. Other examples includes Hadamard codes, Walsh codes, and codes that have low cross-correlation properties.

PN generator 45 multiples each bit obtained from data buffer 43 with the Barker sequence. Accordingly, the signal 424 (output signal of data/PN combiner 46) constitutes either the Barker sequence or the inverse of a Barker sequence (i.e., obtained by multiplying by −1 the code sequences in Table 2). Assuming, for example, that PN generator uses a Barker code of length 11, the time period or delay D equals the length of 11 chips. As another example, FIG. 12 illustrates one chip time, which relates to Barker chips in FIG. 6 (signal 562), relating to a Barker code of length 4).

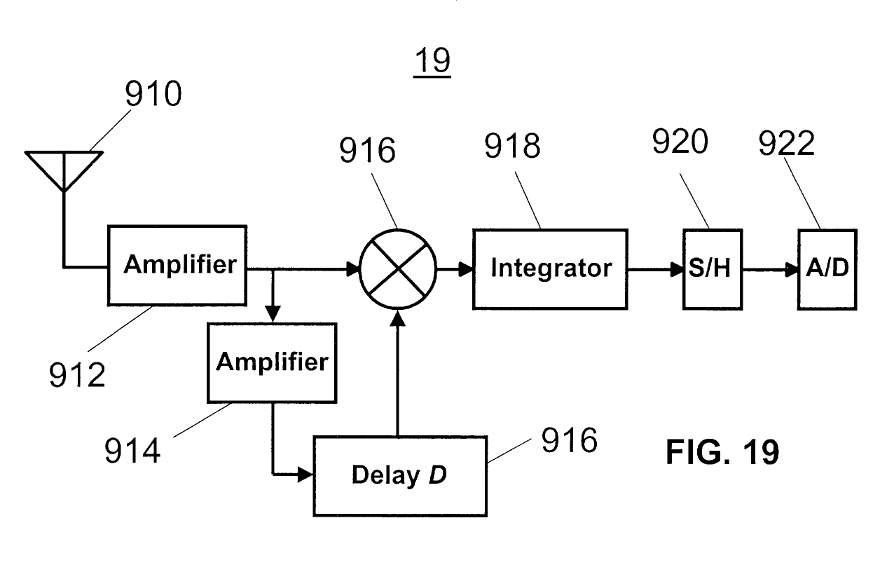

FIG. 19 illustrates an exemplary embodiment 19 of a differential receiver according to the invention that is suitable for receiving DPSK signals. Receiver 19 includes antenna 910, mixer 916, integrator 918, sample-and-hold 920, and analog-to-digital converter (ADC) 922. Receiver 19 may optionally include amplifier 912 and amplifier 914.

Antenna 910 receives differentially encoded signals. Amplifier 912 amplifies the received signal and provides the resulting signal to one input of mixer 916 and amplifier 914. Through delay device 916, the output signal of amplifier 916 (if used) couples to another input of mixer 916.

The delay D provided by delay device 916 equals one bit time. Accordingly, mixer 916 multiplies the received signal by a version of the received signal delayed by a time period D. Because of the differential coding of the signals (described above), a bit sign in the delayed version of the received signal changes when receiver 19 receives a binary “1.”

The output of mixer 916 feeds integrator 918. The output of mixer 916 constitutes a +1 Barker sequence of Table 2 multiplied by an inverse Barker sequence, thus resulting in a negative going voltage at the output of integrator 918 over the length of the Barker code. Sample-and-hold 920 samples the output signal of integrator 918 when that signal crosses a threshold. Sample-and-hold 920 provides the sampled signal to ADC 922. ADC 922 provides output data bits.

Note that, in illustrative embodiments, the length of the integration may be the time period D. Based on design and performance specifications, however, one may use longer or shorter time periods, as persons of ordinary skill in the art who have the benefit of the description of the invention understand. Optional amplifiers 912 and optional amplifier 914 may constitute either linear amplifiers or limiting amplifiers, as desired. One may additionally use amplifier 914 to compensate for any losses in delay device 916. Note that one may place amplifier 912 as shown in FIG. 19 or, alternatively, after delay device 916.

One may implement delay device 916 in a variety of ways, as persons of ordinary skill in the art who have the benefit of the description of the invention understand. For example, a relatively simple delay device comprises a length of transmission line that has electrical length D. One may use a length of coaxial line, printed strip-line, or microstrip in various ways to realize such a device.

Implementing amplifier 912 and amplifier 914 as limiting amplifiers relaxes the design demands on mixer 916. Mixer 916 may have a variety of structures and circuitry, as persons of ordinary skill in the art who have the benefit of the description of the invention understand. For example, mixer 916 may constitute a passive ring diode mixer or a four-quadrant multiplier, as desired.

In conventional DPSK systems, the data bits constitute a length D equal to the length of one data bit. Such systems modulate the phase of the carrier (0 or π/2 radians) at the bit rate. In contrast, communication systems or apparatus according to the invention use a Barker encoded sequence of harmonic wavelets (as shown, for example, in FIG. 6) instead of the carrier in conventional systems. Communication systems or apparatus according to the invention modulate the polarity of the wavelets (i.e., +1 or −1) at the chip rate. Furthermore, they polarity modulate the chip sequences at the bit rate. Thus, in contrast to conventional DPSK systems, in communication systems and apparatus according to the invention, the bit time (see signal 563 in FIG. 6) comprises a coded sequence of wavelets.

Note that receiver 19 and associated circuitry may perform additional functionality. For example, such circuitry may recover the data bits, recover timing of the chip sequences, and fine tune the integration time of integrator 918 in response to signal quality, as persons of ordinary skill in the art who have the benefit of the description of the invention understand.

Note that the exemplary embodiments described above associate each data bit with a spreading code of length N. More specifically, one may use Barker codes of lengths N=2, 3, 4, 5, 7, 11, and 13. Thus, one may associate N chips with a single data bit. As an example, using a Barker code of length 7 (see Table 2, above), one may transmit a “1” by using the sequence 1 1 1 −1−1 1 −1. Similarly, to transmit a “0,” one may use the sequence −1 −1 −1 1 1 −1 1 (i.e., a sequence obtained by multiplying by −1 each number in the previous sequence).

In other embodiments according to the invention, one may use codes that have a larger length than needed to encode a single bit. Doing so may have several advantages. First, the spectrum of the resulting signal more closely resembles white noise (i.e., the benefit of spectrum “whiteness”).

Second, one may use such codes to provide channelization. Longer codes have a relatively large number of nearly-orthogonal family members. One may use such family members to represent both various symbols (i.e., groups of bits) and to provide more effective channelization.

As an example, one may use PN sequence generated which the TIA-95 code division multiple access (CDMA). Such a sequence is 32,768 chips long. One may define channels and symbols by multiplying (e.g., by using an exclusive-OR operation) the PN sequence (at the chipping rate) with a Hadamard code or a Walsh code (i.e., repeated sequences like 1111111100000000, 1111000011110000, 1100110011001100, and so on, as persons skilled in the art understand). Thus, groups of chips are uniquely identify a symbol or channel. Such a techniques takes advantage of a code length of 32,767 to obtain a signal with a relatively smooth spectrum.

In addition to using relatively long codes to provide channelization, one may use other techniques, such as such as time-division multiplexing and space-division multiplexing (using directional antenna techniques to isolate links), as desired. Such techniques fall within the knowledge of persons of ordinary skill in the art who have the benefit of the description of the invention.

In addition to coding the transmitted data in embodiments according to the invention as described above, one may provide error-correction coding (ECC), as desired. For example, one may apply ECC to data input 44 in FIG. 3, as desired. Many such codes exist in the art, and one may apply them to communication systems and apparatus according to the invention as persons skilled in the art with the benefit of the description of the invention understand. Examples of such codes include BCH codes, Reed-Solomon codes, and Hamming codes.

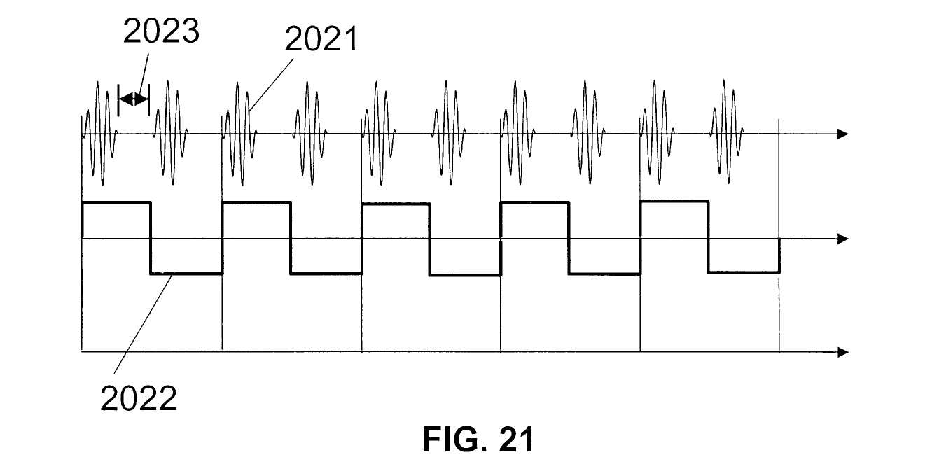

As noted above, the carrier signal (e.g., carrier signal 21 in FIG. 2) may constitute a sinusoidal or non-sinusoidal carrier signal. FIG. 21 shows examples of some signal waveforms corresponding to a non-sinusoidal carrier signal. FIG. 21 includes a repeating pattern “1010” of chips 2022. Signal 2021 corresponds to the “1010” repeating pattern of chips. As FIG. 21 illustrates, signal 2021 may have a gap 2023 of an arbitrary length (with the parameters of signal 2022, of course) between its segments.

Apparatus and methods according to the invention are flexible and lend themselves to a broad range of implementations, as persons of ordinary skill in the art who have the benefit of the description of the invention understand. One may design, implement, and manufacture communication apparatus and systems according to the invention using a wide variety of semiconductor materials and technologies. For example, one may use silicon, thin-film technology, silicon-on-insulator (SOI), silicon-germanium (SiGe), gallium-arsenide (GaAs), as desired.

Furthermore, one may implement such systems and apparatus using n-type metal oxide semiconductor (NMOS), p-type metal oxide semiconductor (PMOS), complementary metal oxide semiconductor (CMOS), bipolar junction transistors (BJTs), a combination of BJTs and CMOS circuitry (BiCMOS), hetero-junction transistors, and the like, as desired. The choice of semiconductor material, technology, and design methodology depends on design and performance specifications for a particular application, as persons of ordinary skill in the art who have the benefit of the description of the invention understand.

Note that, by taking advantage of standard semiconductor devices and fabrication technology, one may manufacture communication systems and apparatus according to the invention with high yield, high reliability, and low cost. For example, one may manufacture such systems and apparatus using standard mixed-signal CMOS processes. This flexibility allows manufacture and marketing of high data-rate consumer products, professional products, health-care products, industrial products, scientific instrumentation, military gear, and the like, that employ communication systems and apparatus according to the invention.

Although the above description of communication systems and apparatus relates to wireless communications, one may use the disclosed inventive concepts in other contexts, as persons of ordinary skill in the art who have the benefit of the description of the invention understand. For example, one may realize high data-rate land-line (i.e., using cables, fiber optics, house wiring, coaxial lines, twin-lead lines, telephone lines, cable television lines, and the like) communication systems and apparatus, as desired.

Put another way, one may omit the antennas (and any associated circuitry) and couple the transmitter and receiver together via a transmission line such as a wire line or an optical fiber. In such systems, one obtains the same or similar benefits as the wireless counterparts. More specifically, the UWB signal can coexist with other signals on the same transmission medium.

The spectra shown in various figures (e.g., FIGS. 13-16) are representative of transmitted and emitted spectra. Radio wave propagation in free space exhibits no frequency dependency, so the field strength PSD at the receiver is the same as the transmitted PSD, and the signal attenuates as 1/(4πr²). As noted above, if one receives the signal with a constant-aperture type of antenna, then the received spectrum equals the transmitted spectrum. An example of a constant-aperture antenna is a wide-band horn or a wide-band parabola whose gain increases as the square of frequency.

On the other hand, if one receives the signal with a constant-gain type of antenna, then the received spectrum will have an imposed 1/f² characteristic. An example of a suitable constant-gain antenna is a wide dipole whose gain is essentially flat with frequency. Non-free-space environments exhibit frequency dependencies in a non-free space environment. Those effects, however, are essentially equal whether one employs a constant-aperture or a constant-gain antenna is employed.

Referring to the figures, the various blocks shown (for example, FIG. 3 or FIG. 5) depict mainly the conceptual functions and signal flow. The actual circuit implementation may or may not contain separately identifiable hardware for the various functional blocks. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have read the disclosure of the invention will understand.

Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

I claim:

1. A communication transmitter apparatus, comprising:
a reference clock generator, the reference clock generator configured to provide a reference clock signal having a prescribed frequency;
a harmonic signal generator, the harmonic signal generator configured to provide one or more harmonic signals of the reference clock signal; and
a modulator, the modulator configured to modulate the one or more harmonic signals with an input signal.

2. The communication transmitter apparatus according to claim 1, wherein the one or more harmonic signals are synchronized to the reference clock signal.

3. The communication transmitter apparatus according to claim 2, further comprising a mixer, the mixer configured to mix the one or more harmonic signals provided by the harmonic signal generator with a first signal derived from the input signal to generate an output signal of the communication transmitter apparatus.

4. The communication transmitter apparatus according to claim 3, further comprising a combiner, the combiner configured to combine a second signal derived from the input signal with a code signal to provide the first signal.

5. The communication transmitter apparatus according to claim 4, further comprising a code generator, the code generator configured to provide the code signal.

6. The communication transmitter apparatus according to claim 5, wherein the code signal comprises a pseudo-random noise signal.

7. The communication transmitter apparatus according to claim 6, wherein the output signal of the communication transmitter apparatus comprises a binary phase shift keyed (BPSK) signal.

8. A communication receiver apparatus, comprising:
a reference clock generator, the reference clock generator configured to provide a reference clock signal having a prescribed frequency;
a harmonic signal generator, the harmonic signal generator configured to provide one or more harmonic signals of the reference clock signal; and
a demodulator, the demodulator configured to use a signal derived from the one or more harmonic signals to demodulate an input signal of the communication receiver apparatus.

9. The communication receiver apparatus according to claim 8, wherein the one or more harmonic signals are synchronized to the reference clock signal.

10. The communication receiver apparatus according to claim 9, further comprising a mixer, the mixer configured to mix the input signal with a first signal derived from the one or more harmonic signals provided by the harmonic signal generator to generate a mixed signal.

11. The communication receiver apparatus according to claim 10, further comprising a combiner, the combiner configured to combine the one or more harmonic signals with a code signal to provide the first signal.

12. The communication receiver apparatus according to claim 11, further comprising a code generator, the code generator configured to provide the code signal.

13. The communication receiver apparatus according to claim 12, wherein the code signal comprises a pseudo-random noise signal.

14. The communication receiver apparatus according to claim 13, further comprising an integrator/sampler, the integrator/sampler configured to integrate the mixed signal to provide an output signal of the communication receiver apparatus.

15. The communication receiver apparatus according to claim 14, wherein the input signal of the communication receiver apparatus comprises a binary phase shift keyed (BPSK) signal.

16. A method of generating a transmission signal, comprising:
generating a reference clock signal, the reference clock signal having a prescribed frequency;
generating one or more harmonic signals of the reference clock signal; and
modulating the one or more harmonic signals with an input signal to generate the transmission signal.

17. The method according to claim 16, wherein generating the one or more harmonic signals further comprises synchronizing the one or more harmonic signals to the reference clock signal.

18. The method according to claim 17, wherein modulating the one or more harmonic signals further comprises mixing the one or more harmonic signals with a first signal derived from the input signal to generate the transmission signal.

19. The method according to claim 18, wherein modulating the one or more harmonic signals further comprises combining a second signal derived from the input signal with a code signal to provide the first signal.

20. The method according to claim 19, wherein modulating the one or more harmonic signals further comprises providing the code signal by using a code generator.

21. The method according to claim 20, wherein providing the code signal further includes providing a code signal that comprises a pseudo-random noise signal.

22. The method according to claim 21, wherein the transmission signal comprises a binary phase shift keyed (BPSK) signal.

23. A method of receiving a communication signal, comprising:
generating a reference clock signal, the reference clock signal having a prescribed frequency;
generating one or more harmonic signals of the reference clock signal; and
demodulating the communication signal by using a signal derived from the one or more harmonic signals to generate an output signal.

24. The method according to claim 23, wherein generating the one or more harmonic signals further comprises synchronizing the one or more harmonic signals to the reference clock signal.

25. The method according to claim 24, wherein demodulating the communication signal further comprises generating a mixed signal by mixing the communication signal with a first signal derived from the one or more harmonic signals.

26. The method according to claim 25, wherein demodulating the communication signal further comprises combining the one or more harmonic signals with a code signal to provide the first signal.

27. The method according to claim 26, wherein demodulating the communication signal further comprises providing the code signal by using a code generator.

28. The method according to claim 27, wherein providing the code signal further includes providing a code signal that comprises a pseudo-random noise signal.

29. The method according to claim 28, wherein demodulating the communication signal further comprises integrating the mixed signal to provide the output signal.

30. The method according to claim 29, wherein the communication signal comprises a binary phase shift keyed (BPSK) signal.
